(19) United States
(12) Patent Application Publication
(10) Pub. No.: US 2017/0103721 A1
(43) Pub. Date: Apr. 13, 2017

(54) METHOD FOR IMPROVED VIEWABILITY OF LIQUID CRYSTAL DISPLAYS

(71) Applicant: HONEYWELL INTERNATIONAL INC., Morris Plains, NJ (US)

(72) Inventors: Victoria P. Haim, Glendale, AZ (US); Steven Haim, Glendale, AZ (US); Elias S. Haim, Glendale, AZ (US); Richard Weimer, Peoria, AZ (US)

(73) Assignee: HONEYWELL INTERNATIONAL INC., Morris Plains, NJ (US)

(21) Appl. No.: 15/052,434

(22) Filed: Feb. 24, 2016

Related U.S. Application Data
(60) Provisional application No. 62/240,011, filed on Oct. 12, 2015.

(51) Int. Cl. G09G 3/36

(52) U.S. Cl. CPC G09G 3/3648; G09G 2300/0452; G09G 2320/041; G09G 2320/066; G09G 2320/0666; G09G 2320/0673; G09G 2320/0204

(57) ABSTRACT

The viewability of a liquid crystal display (LCD) having an empirically determined, non-adjustable display characteristic, and having an active matrix array of display pixels, is improved by adjusting drive voltages to the active matrix array of display pixels based on the empirically determined, non-adjustable display characteristic to attain a predetermined viewing characteristic.

### CROSS-REFERENCE TO RELATED APPLICATION

This application claims the benefit of U.S. Provisional Patent Application No. 62/240,011, filed Oct. 12, 2015, which is incorporated herein by reference.

### TECHNICAL FIELD

The present invention generally relates to liquid crystal displays (LCDs), and more particularly relates to a method for improving the viewability of LCDs.

### BACKGROUND

There are many different displays in the market that have specific aspect ratios of width to height that are designed for particular applications and defined optical performance. At times, it may be desirable to change the aspect ratio or the installation, which in turn may change an end user's viewing cone, while maintaining the same optical performance. In some instances, however, problems may arise if the LCD includes a wide view compensation film designed for a particular aspect ratio and installation.

A particular instance of the problem described above may occur when the wide view compensation film for a twisted nematic (TN) LCD is changed. This change can involve modification of certain parameters, such as the film retardance and the tilt angle, and thereby impact the visual performance within the viewing cone for the end user preference. Specifically, it may be more favorable for horizontal viewing than for vertical viewing, or vice-versa. If the display has been optimized for horizontal viewing, loss of optical performance in the vertical viewing direction due to light leakage at the low gray scales and in the off-state can occur, and vice-versa.

Unsurprisingly, much of the current display market is trending toward wider screens with improved horizontal viewing. As a result, color shifts, inversion at low gray scales, and lower off-axis contrast are not uncommon for vertical viewing situations. This can be an issue in certain applications, such as avionic applications, where the design eye point is above the display. The color shifts of the dark, or off-state can result in a bluish or sometimes reddish background at certain angles, as well as inversion and color shifts at the low gray scales, that can be detrimental to the use of video and the widely popular synthetic vision functionality desired by many avionic display users.

Hence, there is a need for a reliable yet convenient method to adjust the performance parameters for vertical optimization or horizontal optimization by taking into account one or more key LCD parameters. Some applications will require or at least benefit from more dynamic viewing cones for different installations types and real time display orientation changes. The method can also be developed for these unique situations. The solutions proposed take into account numerous performance parameters required for acceptable avionic displays, but are applicable to other display implementations as well.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In one embodiment, a method of improving the viewability of a liquid crystal display (LCD) having an empirically determined, non-adjustable display characteristic, and having an active matrix array of display pixels includes adjusting drive voltages to the active matrix array of display pixels based on the empirically determined, non-adjustable display characteristic to attain a predetermined viewing characteristic.

In another embodiment, a method of improving the viewability of a liquid crystal display (LCD) having a characteristic retardance, and having an active matrix array of display pixels includes adjusting drive voltages to the active matrix array of display pixels based on the characteristic retardance to minimize light leakage at low gray levels or full-off states of the display pixels.

In yet another embodiment, a method of improving the viewability of a liquid crystal display (LCD) having a characteristic retardance, and having an active matrix array of display pixels includes sensing a temperature that is at least representative of at least a portion the LCD; and adjusting drive voltages to the active matrix array of display pixels based on the characteristic retardance and the sensed temperature to minimize light leakage at low gray levels or full-off states of the display pixels.

Furthermore, other desirable features and characteristics of the method will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 depicts a functional block diagram of one example of a liquid crystal display (LCD) device;

FIG. 2 schematically depicts a methodology for improving the viewability of certain LCDs;

FIG. 3 graphically depicts how reducing the optically-off drive voltage of an LCD with the undesirable light leakage shifts its gamma curve back toward that of an LCD that exhibits desirable characteristics;

FIGS. 4 and 5 graphically depict contrast performance of an LCD before and after drive voltage correction, respectively;

FIGS. 6 and 7 graphically depict the impact on response time for an LCD configuration having a first cell gap and a second cell gap, respectively;

FIG. 8 depicts the use of sensing means in the selection of predetermined viewing characteristics.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

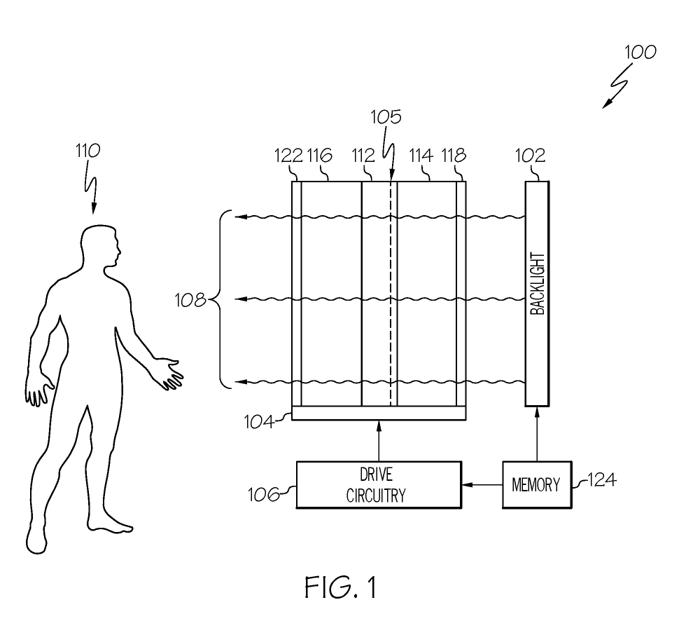

Referring to FIG. 1, a simplified cross-sectional side view of one embodiment of a liquid crystal display (LCD) 100 is depicted, and includes a backlight 102, an LCD panel 104, a plurality of display elements (or pixels) 105, and display drive circuitry 106. The backlight 102, which may be variously configured and implemented, generates light 108. The light 108 passes through display elements 105 and illuminates images generated on LCD panel 104 for viewing by a user 110.

The display elements 105 are built on substrate 114 of the LCD panel 104 and then assembled to a second substrate 116. The liquid crystal layer 112 is disposed between the first and second display layers 114, 116, and may be any one of numerous types of liquid crystal configurations. In one particular embodiment, the liquid crystal layer 112 comprises twisted nematic (TN) liquid crystal. The LCD panel 104 outer layers are comprised of a first and second polarizer 118 and 122. As is generally known, the LCD panel 104 and backlight 102 are typically subassemblies within the LCD 100.

The first and second display layers 114, 116 are disposed between the first and second polarizers 118, 122, and are formed of transparent layers such as, for example, transparent layers of glass or plastic. The first and second display layers 114, 116 may, in some embodiments, have color filter elements (e.g., red, green, and blue) and/or thin-film transistor (TFT) and associated electrodes (e.g., display pixel electrodes) formed thereon. It is noted that one or both of the first and second polarizers 118, 122, in addition to polarizing incident light, may also include compensation films, such as a wide view compensation film.

The drive circuitry 106 is coupled to the display elements 105 and is configured to supply drive voltages to the first and second display layers 114, 116 to thereby display images on the LCD 100. For example, in a typical TN LCD, when low or no drive voltage is applied to the first and second display layers 114, 116, the liquid crystals arrange themselves in a helical or twisted structure. This induces the rotation of the polarized light 108 as it passes through the liquid crystal layer 112, and the device appears gray or white. If the drive voltages are large enough, the liquid crystals “untwist,” and the polarized light 108 is not rotated as it passes through the liquid crystal layer 112. As a result, the light will be absorbed by the second polarizer 122, and the pixel will appear black. By controlling the voltage applied across the liquid crystal layer 112 in each pixel, light can be allowed to pass through in varying amounts, thus constituting different levels of gray.

The drive circuitry 106 may, in some embodiments, be in operable communication with a memory 124. The memory 124, if included, may have a plurality of predetermined drive voltages stored therein. The purpose and use of these predetermined drive voltages is described further below.

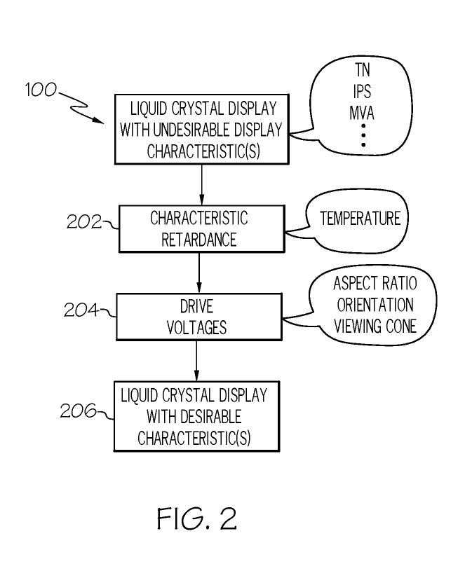

With the above background in mind, and turning now to FIG. 2, it is known that LCDs, such as the one depicted in FIG. 1, exhibit what is known as a retardance, or characteristic retardance. As used herein, the term characteristic retardance refers to a parameter or metric that is representative of the product of cell gap (d) and birefringence (Δn), where the cell gap is the thickness of the birefringent liquid crystal layer 112. Once the LCD panel 104 is fabricated, the characteristic retardance of that panel can be empirically measured or otherwise determined, and is not readily adjustable. As noted in the background section, an LCD 100 (of various types of LCD technologies) that includes a wide view compensation film may exhibit undesirable optical characteristics, such as undesirable light leakage, when implemented using cell gaps, retardance values, display aspect ratios or a viewing cone, which differ from the nominal design for which the compensation film is optimized. As used herein, viewing cone refers to the range of viewing angles from which the user 110 sees any portion of the display surface.

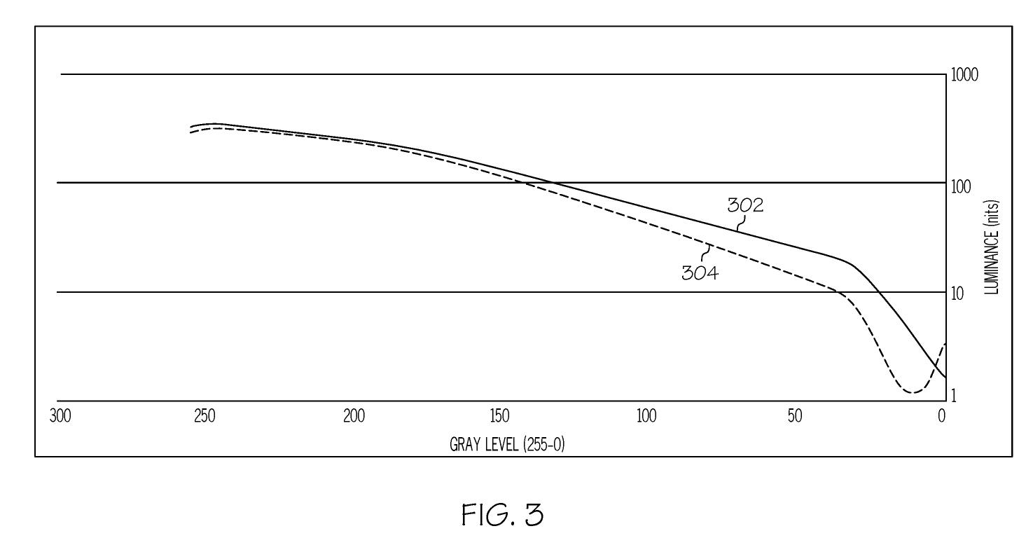

By characterizing (e.g., measuring or calculating) the impact of various drive voltages versus retardance (or characteristic retardance) 202 for the LCD 100, the light leakage can be reduced or eliminated. In particular, based on the voltage-versus-retardance (or characteristic retardance) characteristics of the LCD 100, the optically-off voltages 204 to the RGB sub-pixels can be optimized to limit the light leakage or washout and thereby provide an LCD 100 with desirable characteristics 206. More specifically, this can be done by modifying the analog voltage required to drive the dark state, and possibly other low gray level states as well. One example of this is depicted in FIG. 3, where curve 304, often referred to as a response curve or gamma curve, exhibits non-asymptotic behavior as the gray scale setting approaches zero. In this example, which depicts the response of a particular normally white (NW) LCD mode, reducing the gray scale setting corresponds to increasing the drive voltage applied to the LCD 100. Limiting or reducing the optically-off drive voltage of the LCD 100 to avoid the non-asymptotic portion of gamma curve 304 (that portion to the right of the local minimum in curve 304) substantially eliminates the light leakage, effectively shifting its gamma curve 304 back toward that of an LCD that exhibits desirable characteristics (e.g., little or no light leakage) 302 with the optically-off drive set at the minimum luminance depicted on the y-axis.

It will be appreciated that reducing the drive voltage below the full analog range defined by the driver specification can be implemented on one, two, or all three of the RGB sub-pixels. The methodology can be used to minimize the color separation of the off-state or low gray level between the design eye (i.e., nominal) position for the application and the angle in the viewing cone showing the most color shift, typically high vertical angles. Another instance to optimize performance is to find the point of luminance inversion at the low RGB gray levels. It will additionally be appreciated that trade-offs can be made to match display performance to fit viewing envelope requirements. Once the optimized drive voltage is found, it may preferably be stored in the memory 124 and used in the control circuitry 106 that commands the RGB drive voltages for the off-state or low gray level shade.

In addition to the above, it is generally known to persons skilled in the art that for a particular liquid crystal material, the effective retardance characteristic typically varies in a consistent manner with temperature. Thus, as FIG. 2 also depicts, the methodology may also be used to address changes attributable to the wide view compensation effectiveness over temperature. In particular, it has been shown that the optimized drive voltages to mitigate light leakage also shift with temperature. Moreover, depending on the display orientation (e.g., vertical to horizontal) the LCD can be optimized for that orientation using the optimized drive voltages. Thereafter, if the orientation of the display is changed, this change can be detected via, for example, an accelerometer or any one of numerous other mechanical or electrical sensing devices, and the drive voltages can be updated in real time.

As somewhat alluded to above, the optimum RGB drive voltages for the LCD panel 104 are a function of cell gap (d). As such, the methodology described herein can be extended, if needed or desired, by deriving look-up tables based on empirical data collected on modules of various cell gaps with one or more given wide view compensation films. Having derived the look-up tables, the optimized drive voltages associated with the cell gap (d) of the LCD panel 104 can then be programmed into the memory 124. With this capability, there is no need for further calibration. All that a system integrator or end-user would need is the cell gap or related retardance parameter or characteristic. In one embodiment of the method of FIG. 2, the drive voltages in 204 are pre-selected for an LCD panel 104 based upon the characteristic retardance of that panel and programmed into memory 124. In another embodiment, a broader set of drive voltages are programmed into memory 124, and the characteristic retardance of LCD panel 104 is used as an index for selecting the drive voltages to be applied to that panel.

From the previous paragraph it may be appreciated that if the relationship between the optimized RGB voltages for the off-state has been characterized, then the cell gap can be empirically determined from straightforward photometric measurements of a completed LCD panel or display system.

The temperature dependence of the retardance, and in particular the birefringence Δn, can be incorporated into the characteristic retardance directly, prior to using the characteristic retardance to establish or index into the drive voltages programmed into memory 124. Alternately, the set of drive voltages programmed into memory 124 can be expanded to include voltages covering a range of temperatures. In either case, a key distinction is that the set of drive voltages are drawn from look-up tables or formulas based on the collective analysis of multiple LCD modules, whereas the actual drive voltages for a particular LCD panel are subsequently selected from those prior results based upon the empirically determined characteristic retardance of that panel.

It is the goal of this method to attain a predetermined and desirable viewing characteristic or performance, as shown in step 206 of FIG. 2. The method is extendable to cover multiple sets of viewing characteristics. One such extension is the choice of predetermined viewing characteristics based upon orientation of an LCD panel 804, such as the one depicted in FIG. 8. As mentioned above, the orientation of the LCD panel 804 can be detected using any one of numerous types of sensing devices 830, such as, for example, one or more accelerometers, and the drive voltages for multiple orientations can be programmed into the memory 124 (not depicted in FIG. 8). The change in orientation can, for example involve a change in the desired viewing cone for a viewer 810. Operation is consistent with the method of FIG. 2 when the drive voltages to be applied are determined, selected or otherwise adjusted based on the characteristic retardance of the LCD panel being driven.

Yet another embodiment of applying the method to multiple sets of viewing characteristics is also shown in FIG. 8. In this embodiment, one or more tracking units 832 function as sensing means to detect the location or orientation of the preferred viewing cone by, for example, monitoring the location of a viewer 810 along directional axes 834 and relative to the location of the LCD panel 804. With the viewing cone identified, the characteristic retardance would be used to select drive voltages which improve one or more predetermined viewing characteristics, such as contrast within the viewing cone. Again, the drive voltages for the corresponding predetermined viewing characteristics associated with the tracked configuration are selected based upon the empirically determined characteristic retardance without the need for extensive LCD panel-specific calibrations.

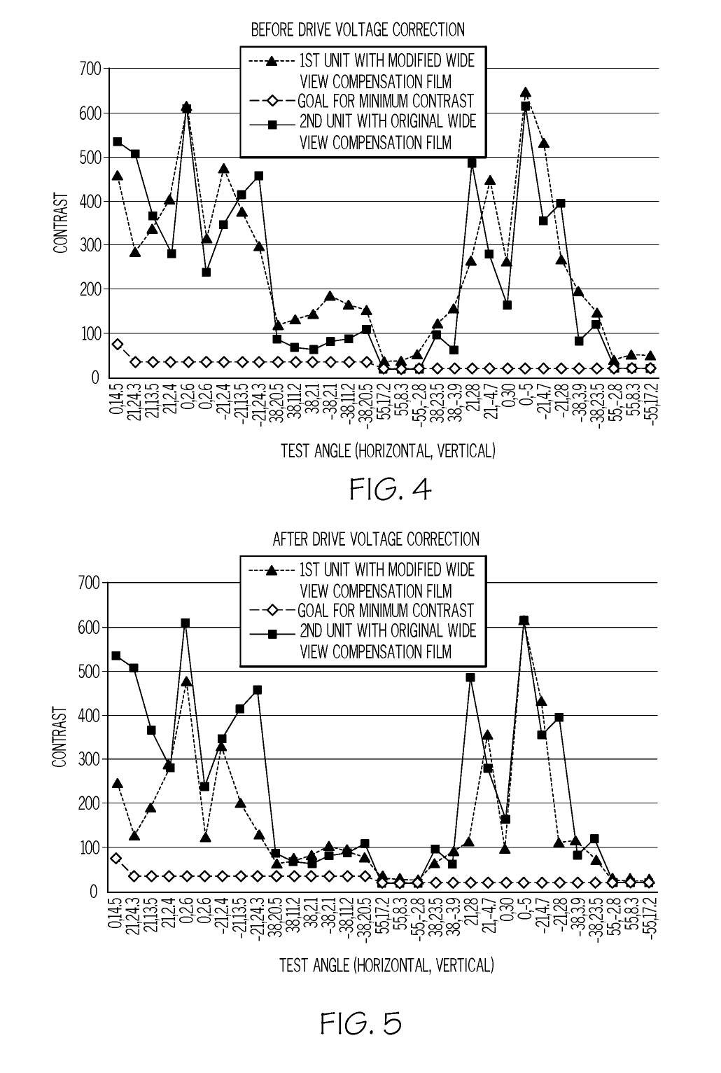

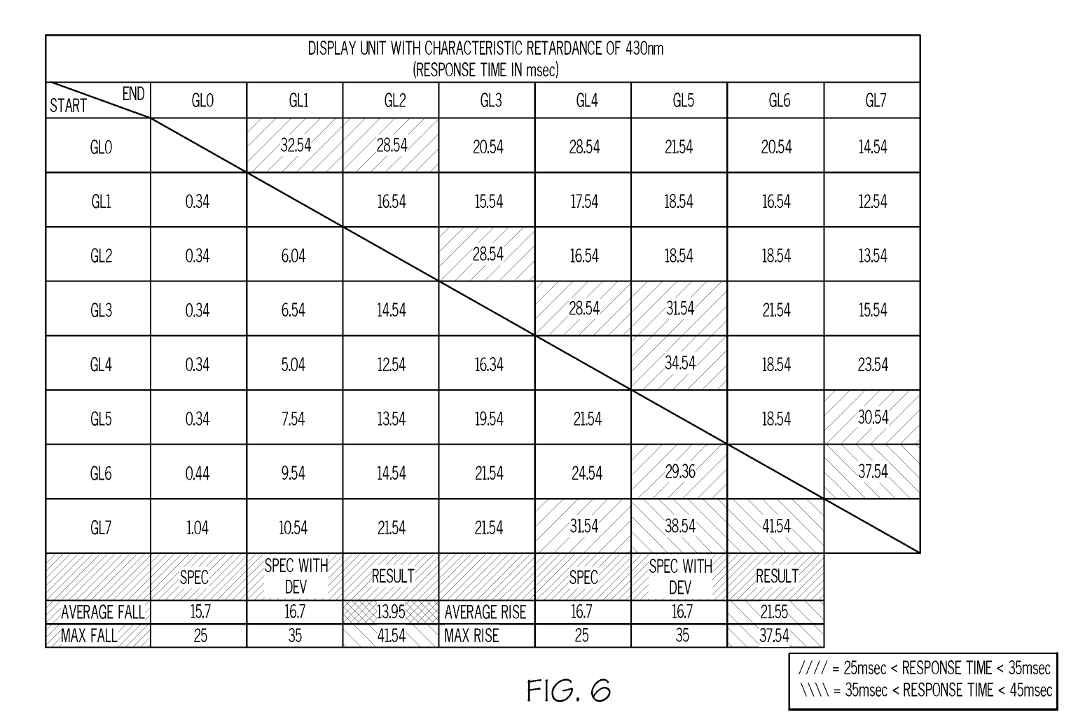

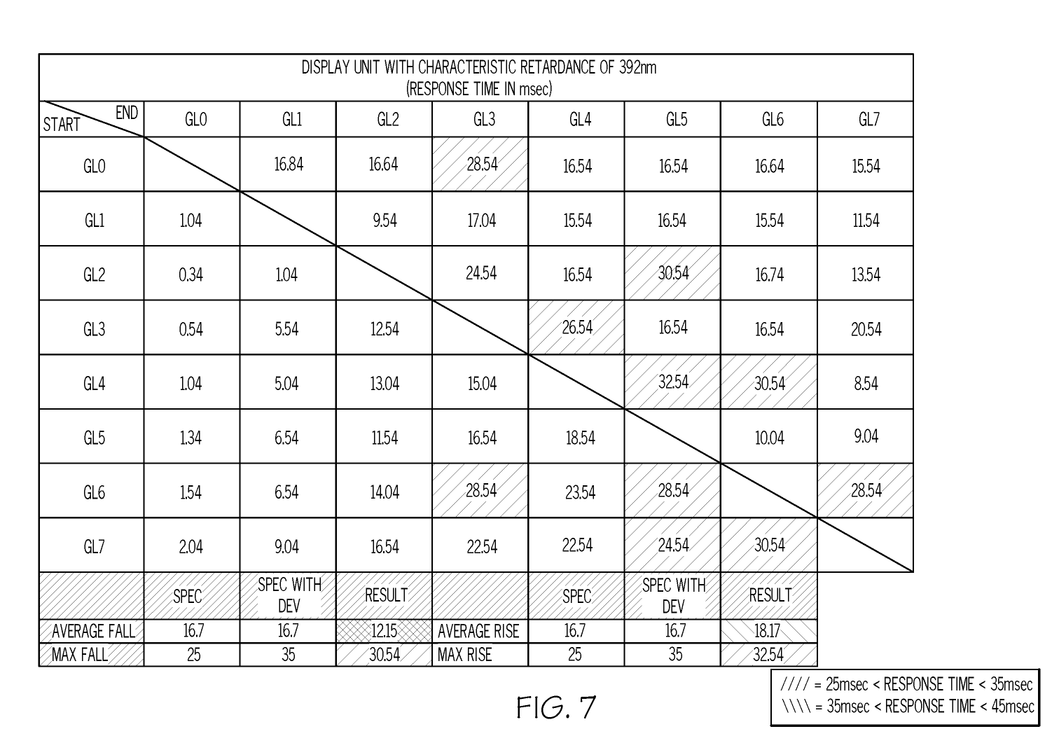

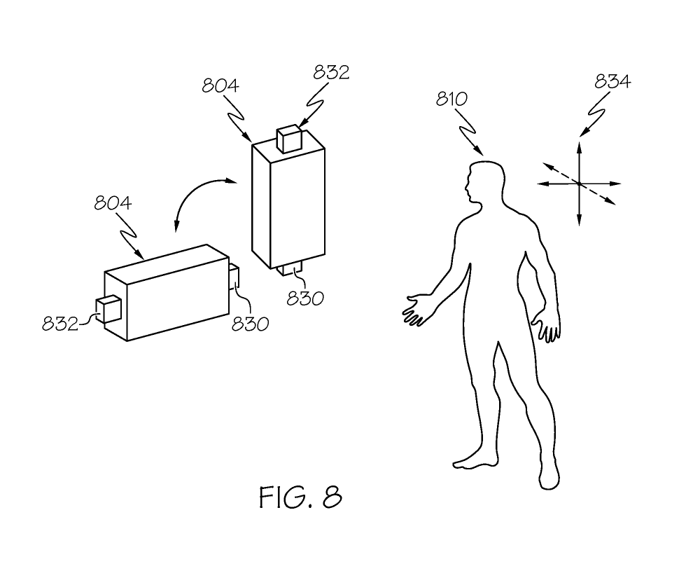

It should be noted that optimizing the optically-off drive voltages of the LCD panel 104, as described herein, can significantly improve the color performance of the LCD 100. However, there are certain trade-offs associated therewith. In particular, there may be a slight adverse impact to the contrast performance (e.g., the black state may be brighter) and to the response time. Both the contrast and response time parameters are functions of many variables including cell gap. For a given cell gap, the relationship to retardance is described above. The impact on contrast performance is graphically depicted in FIGS. 4 and 5, which depict contrast performance at key viewing angles before and after the drive voltage correction, respectively. In FIG. 4, the contrast at some off-axis angles is high and becomes reduced when the optically—off voltage is reduced as shown in FIG. 5. The impact on response time is shown in FIGS. 6 and 7, which depict rise and fall response times for a given LCD birefringence, and with cell retardances of 430 nm and 390 nm, respectively. The increase in the cell gap (d) for the 430 nm retardance LCD display increased the response times. These trades are taken into consideration for the cell gap (d) design and manufacturing tolerances that can be addressed with this method.

Whereas the present method has been described primarily in the context of a TN LCD panel and with respect to certain predetermined viewing characteristics, the method can be applied to a wide variety of LCD configurations and predetermined viewing characteristics which vary with the characteristic retardance of the LCD panel.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention.

What is claimed is:

1. A method of improving the viewability of a liquid crystal display (LCD) having an empirically determined, non-adjustable display characteristic, the LCD having an active matrix array of display pixels, the method comprising the steps of:
adjusting drive voltages to the active matrix array of display pixels based on the empirically determined, non-adjustable display characteristic to attain a predetermined viewing characteristic.

2. The method of claim 1, wherein the empirically determined, non-adjustable display characteristic is characteristic retardance.

3. The method of claim 1, wherein the empirically determined, non-adjustable display characteristic varies with temperature, and wherein the method further comprises:
sensing a temperature that is at least representative of at least a portion the LCD; and
adjusting the drive voltages to the active matrix array based additionally on the sensed temperature.

4. The method of claim 1, wherein the drive voltages are adjusted to minimize light leakage at low gray levels or full-off states of the display pixels.

5. The method of claim 4, wherein:
the LCD, prior to adjusting the drive voltages, is characterized, at least in part, by a gamma curve that exhibits non-asymptotic behavior as gray scale voltages approach zero; and
the step of adjusting drive voltages comprises increasing the drive voltages to avoid the non-asymptotic behavior.

6. The method of claim 1, wherein the predetermined viewing characteristic is at least one of contrast or color shift within a viewing cone.

7. The method of claim 1, wherein:
the LCD has an optically OFF state; and
the drive voltages are adjusted to prevent washout of the optically OFF state to thereby improve display contrast.

8. The method of claim 1, wherein the drive voltages are adjusted to minimize color shift and gray level inversion.

9. The method of claim 1, wherein the drive voltages are adjusted to drive off-pixels used to display color to thereby minimize color shift and contrast reduction.

10. The method of claim 1, further comprising:
storing a plurality of drive voltages in a memory; and
adjusting the drive voltages to the active matrix array of display pixels using drive voltages stored in the memory.

11. The method of claim 1, wherein the predetermined viewing characteristic is selected from a set of predetermined viewing characteristics based upon sensing means coupled to the LCD.

12. A method of improving the viewability of a liquid crystal display (LCD) having a characteristic retardance, the LCD having an active matrix array of display pixels, the method comprising the steps of:
adjusting drive voltages to the active matrix array of display pixels based on the characteristic retardance to minimize light leakage at low gray levels or full-off states of the display pixels.

13. The method of claim 12, wherein the characteristic retardance varies with temperature, and wherein the method further comprises:
sensing a temperature that is at least representative of at least a portion the LCD; and
adjusting the drive voltages to the active matrix array based additionally on the sensed temperature.

14. The method of claim 12, wherein:
the LCD, prior to adjusting the drive voltages, is characterized, at least in part, by a gamma curve that exhibits non-asymptotic behavior as gray scale voltages approach zero; and
the step of adjusting drive voltages comprises increasing the drive voltages to avoid the non-asymptotic behavior.

15. The method of claim 12, wherein the predetermined viewing characteristic is at least one of contrast or color shift within a viewing cone.

16. The method of claim 12, wherein:
the LCD has an optically OFF state; and
the drive voltages are adjusted to prevent washout of the optically OFF state to thereby improve display contrast.

17. The method of claim 12, wherein the drive voltages are adjusted to minimize color shift and gray level inversion.

18. The method of claim 12, wherein the drive voltages are adjusted to drive off-pixels used to display color to thereby minimize color shift and contrast reduction.

19. The method of claim 12, further comprising:
storing a plurality of drive voltages in a memory; and
adjusting the drive voltages to the active matrix array of display pixels using drive voltages stored in the memory.

20. A method of improving the viewability of a liquid crystal display (LCD) having a characteristic retardance, the LCD having an active matrix array of display pixels, the method comprising the steps of:
sensing a temperature that is at least representative of at least a portion the LCD; and
adjusting drive voltages to the active matrix array of display pixels based on the characteristic retardance and the sensed temperature to minimize light leakage at low gray levels or full-off states of the display pixels.
